(19) United States
(12) Patent Application Publication
(10) Pub. No.: US 2018/0075393 A1
(43) Pub. Date: Mar. 15, 2018

(54) SYSTEM AND METHOD FOR TRACKING AND VALIDATING SOCIAL AND ENVIRONMENTAL PERFORMANCE

(71) Applicant: LOVELL CORPORATION, Kitchener (CA)

(72) Inventor: KELLY ANN LOVELL, KITCHENER (CA)

(21) Appl. No.: 15/815,694

(22) Filed: Nov. 16, 2017

Related U.S. Application Data
(63) Continuation-in-part of application No. 14/677,880, filed on Apr. 2, 2015.
(60) Provisional application No. 61/973,931, filed on Apr. 2, 2014.
(60) Provisional application No. 62/530,787, filed on Jul. 10, 2017.

(51) Int. Cl. G06Q 10/06; G06Q 50/00; H04W 4/02

(52) U.S. Cl. CPC G06Q 10/06393; H04W 4/02; G06Q 50/01

(57) ABSTRACT

A computer-implemented method and system for calculating a metric of a user's social or environmental performance among a plurality of users. The processor executing the computer executable instructions identifies opportunities for social action be included in a content feed addressable to the user and provides opportunities generated by organizations to the user. The processor monitors interactions between the user and other users/organizations, monitors a type of interaction and associated social/environmental impact of the interactions, stores the interactions in a user profile, and determines from the user profile a social/environmental achievement or new contribution by the user. For each social/environmental achievement/contribution, the processor assigns a numerical value to an amount, a frequency, a location of the user, and a quality of the user profile data representative of the user's influence in each social/environmental achievement or contribution.

### RELATED APPLICATIONS

This application is a continuation-in-part of U.S. application Ser. No. 14/677,880 filed Apr. 2, 2015, which claims the benefit of U.S. Provisional Application No. 61/973,931 filed Apr. 2, 2014, and this application claims the benefit of U.S. Provisional Application No. 62/530,787 filed Jul. 10, 2017, each of which is incorporated herein by reference in its entirety.

### FIELD OF THE INVENTION

The present invention relates generally to a computer implemented system for tracking and verifying volunteer activities. More particularly to system and method for tracking and validating social and environmental services.

### BACKGROUND OF THE INVENTION

Social networking platforms such as Facebook™, Google+™, Foursquare™, LinkedIn™, and Twitter™ have become deeply embedded into the social fabric of modern day life. These platforms support a variety of functions, ranging from sharing daily activities and photos to use as corporate advertising and marketing channels. Many individuals use these sites as sources of news and information about topics of interest such as current events, travel, sports, food, geographic areas, local news, etc. Moreover, companies use these channels to advertise promotions, sales, new products and services, as well as general information. In many instances the messaging and news feeds supplied by these platforms have become the primary method of communication among and for large groups of individuals. This collection of data sent to and viewed by an individual is typically referred to as a “feed.” Recently, sites such as Klout™, HootSute™, and Sprout Social™ have begun aggregating data feeds from the individual social network platforms onto a single platform. This process provides a “global” view of content and its creators and illustrates how it proliferates across the web. Moreover, it allows multiple users who otherwise might not be connected to view and possibly comment on content submitted by others. These feeds however focus on user generated content—information created, verified and shared by individual users and generally involve digital actions (i.e. online content or actions such as liking, commenting or sharing said content). There is a lacking of content related to sharing and documenting physical actions or “offline” actions to be communicated between users and organizations using digital platforms.

The items of an individual's feed typically include a collection of posts, status updates, “check-ins” or other news stories that are pushed out onto the platform by an author. The author can be any entity, such as an individual person, a local business, a school group, a multi-national corporation, a government, or any group of people organized around a cause or topic. In order to receive this information, a user must make an explicit effort to become “linked to” or “follow” the author. This can be accomplished by requesting an individual as a friend or business link, subscribing to a news feed, requesting membership in a group, or similar action. In each case, however, the user must know at least something about who or what is a good source of information about their topic of interest.

Moreover, the user must self-input the information, including verification of their proposed actions and estimating on its impact. As a result, there may be many opportunities related to a particular social cause that exist with one or more organization from which a user would benefit receiving information but has no definitive way of discovering; and the information they input/add to their profile is subjective, leaving little value in comparison between user profiles for organizations to properly assess/rank the quality of a user's actions and social/environmental performance (and vice versa for a user to assess the performance of an organization according to social/environmental indicators that are important to them).

There is a need, therefore, for methods and supporting systems that can identify authors and other sources of information regarding particular topics that have particular relevance and/or meet some minimum level of quality, and send the information to users without the user having to preemptively identify the source and/or verify and document the completion of their actions. Using such techniques would allow users to receive interesting and relevant information about their primary interests, current location and activities without having to necessarily know who the best sources of that information are; and most importantly, efficiently track their actions/social activities in a trusted and reliable way that compile with the data integrity and tracking needs of organizations and third parties (i.e. employers, governments and nonprofit organizations).

Additionally, companies and non-profit organizations are facing increased demands for information about their social and environmental performance. The trend towards external auditing of CSR and sustainability reports has been proven to increase stakeholder relationships and also improve the organization's ability to attract and retain talent. Performance data is thus becoming an increasingly important feature of corporate reports. In our big data era, a Self-Adaptive Platform is required to intelligently analyze performance data. The major goal of such a platform is to provide a novel mechanism not only to perform data analytics but also to dynamically cope with requirement changes and unexpected conditions.

Current methods of tracking and measuring social and environmental performance today still requires validation from a trusted third party like a consultant, auditor, or program coordinator. The alternative method—self-reporting and user generated reports—has even less merit, as they are subject to human error, forgery and information deficiencies. There are many drawbacks to relying heavily on intermediaries to collect, analyze and report on our data. For one, they are centralized, making them vulnerable to manipulation and bias. They add cost and friction to our economy for consumers and businesses alike.

With the development of social/cultural networks, discovering communities in graphs draws much more attention than before. A context in a large data set is considered as a group of nodes with more interactions and common topics among its members than between its members and others, and social impact discovery/performance is the process to group the nodes into the clusters of close interaction and common interests. Most of previous system overlook the connection between interactions and interests, and hence have difficulties in finding the most appropriate context or impacts. The claimed system is different from the previous system in that topic and impacts are treated as different concepts. Instead of modelling topics by considering pair-wise link relationships, the claimed system considers topic modelling at the performance/social impact level. The analysis of topics and social impacts can benefit each other.

Currently available systems and methods for tracking actions utilize two-step process that requires a participant and/or supervisor or host organization to confirm that an action has been completed. This can happen in several ways: In level 1, the participant manually logs their participation, contribution or time, which can potentially result in a high risk of forgery and inaccuracies/human error. In level 2, the participant manually logs their participation and gets it signed/approved/validated by a supervisor via a signature/stamp of approval, etc. This requires time from the supervisor to review and confirm the participant's action. In level 3, the supervisor manually tracks participant action. Unfortunately, this involves self-reporting, risk of human error/inaccuracies and still requires labor/time. Currently available digital solutions allow people to make the process more efficient, but they still require an individual to report/indicate her actions taken without third-party confirmation, i.e. self-reporting.

That is, in the currently available system, validation of action typically occurs after the fact. Whether a participant logs her hours when they get home, submits them for approval or a supervisor records the contributions after an event, this all happens after the action is complete/has passed.

Measuring outcomes is usually a separate occurrence from tracking/confirming action. After a supervisor has confirmed the actions, they may seek to identify outcomes, such as skills development or community impact, etc. This requires the supervisor to either research, estimate based on available data or contact the individual to gain qualitative data to report on these outcomes. Accordingly, it is desirable for both volunteers and non-profit charitable organizations to be able to track and verify the work/service of their volunteers without the problems associated with the currently available systems, such as, the problems associated with the self-reporting.

### OBJECT AND SUMMARY OF THE INVENTION

The techniques, methods and systems described herein facilitate the automated discovery and presentation of social and environmental impact achievements (performance data) created, published or otherwise made public by “experts” and key influencers in particular cause sectors/according to particular social indicators. As such, users that may be interested in particular social topics or seeking opportunities to contribute to a specific cause but may not know who to connect with in order to receive the most pertinent information and find the most suitable opportunities that support their social interests. The system uses cause topics; skill development goals and opportunity types of interest identified by the user and/or automatically identifies opportunities based on previous completed opportunities/actions, communication, social preferences contacts, etc. In parallel, the system identifies individuals, companies, organizations and other entities that have been recognized as highly influential in those cause sectors/social and environmental indicators without explicit actions by the user, adds opportunities posted by the influential entities to the user's opportunity feed. This results in the user receiving highly relevant information on social topics and development opportunities that he would not have otherwise been privy to.

Therefore, in a first aspect, a method for providing a stream of data content items to a user of a social network platform includes storing, on a physical memory device, computer-executable instructions for identifying sources of opportunities to be included in a content feed addressable to the user and providing content generated by the sources (i.e. organizations like employers and nonprofits) to the user. A processor is provided, that when used to execute the instructions identifies opportunities interest of the user based on a list self-selected cause interests, types of opportunities/actions previously selected/completed by the user, the user's location (or future location), the user's activities (past, present and/or future) and/or previously supported organizations selected by the user.

In another aspect, a system for providing data content items to a user of a social network platform includes a data storage device for storing information related to social topics and opportunity types of interest relevant to the user, an opportunity discovery engine and a content communications device. The topics of interest include list self-selected topics, topics identified from user-generated content provided by the user, the user's location (or future location), the user's activities (past, present and/or future) and/or previously completed opportunities/action types selected by the user. The opportunity discovery engine identifies social actions of interest for the user based at least in part on the stored information and identifies organizations and opportunities sources not previously known to the user as relevant sources of information about the identified topics of interest. The content communications device receives content items from the identified content sources and automatically includes the received content items in the user's content feed.

In accordance with an exemplary embodiment of the claimed invention, a computer-implemented method and system is provided for calculating a metric of a user's social or environmental performance among a plurality of users. The processor executing the computer executable instructions identifies opportunities for social action be included in a content feed addressable to the user and provides opportunities generated by organizations to the user. The processor monitors interactions between the user and other users/organizations, monitors a type of interaction and associated social/environmental impact of the interactions, stores the interactions in a user profile, and determines from the user profile a social/environmental achievement or new contribution by the user. For each social/environmental achievement/contribution, the processor assigns a numerical value to an amount, a frequency, a location of the user, and a quality of the user profile data representative of the user's influence in each social/environmental achievement or contribution.

### BRIEF DESCRIPTION OF THE DRAWINGS

FIG. 1 is a block diagram of a plurality of client devices, a social network server, a mobile telephone network server, and a web application server coupled via a network in accordance with an exemplary embodiment of the claimed invention;

FIG. 2 depicts an example system for running a volunteer service project through a social-media based platform including a web application server coupled to a project database and participant database in accordance with an exemplary embodiment of the claimed invention;

FIG. 3A depicts an example of a social media user database storing a social media user's profile information and network contacts in accordance with an exemplary embodiment of the claimed invention.

FIG. 3B depicts an example of a participant database storing participant profile information and participant responses in accordance with an exemplary embodiment of the claimed invention;

FIG. 3C depicts an example of a project database storing organization profile information, project information, and project banners in accordance with an exemplary embodiment of the claimed invention;

FIG. 4 depicts a flow chart of a process of establishing a volunteer service project with a web application server in accordance with an exemplary embodiment of the claimed invention;

FIG. 5 depicts a flow chart illustrating an exemplary operation of the claimed system; and

FIG. 6 is a block diagram of a client device in accordance with an exemplary embodiment of the claimed invention.

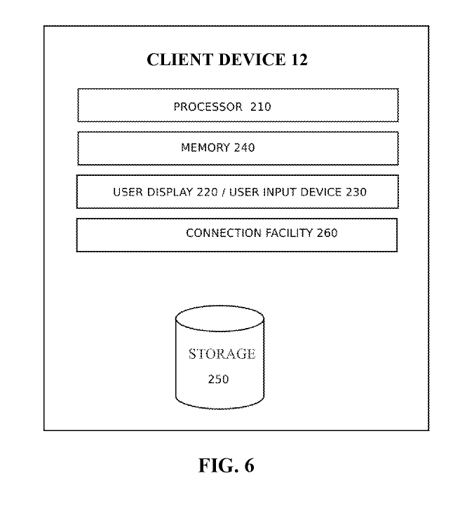

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE EMBODIMENTS

With parenthetical reference to the corresponding parts, portions or surfaces of the disclosed embodiment, merely for the purposes of illustration and not by way of limitation, the present invention provides a mobile application for volunteer service tracking, promotion and participation. The system running the application includes a plurality of client devices with user interlaces, a mobile telephone network server, a mobile telephone user database, a web application server, a participant database, and a project database coupled via a network, according to an exemplary embodiment of the claimed invention.

At the outset, it should be clearly understood that like reference numerals are intended to identify the same structural elements, portions or surfaces consistently throughout the several drawing figures, as such elements, portions or surfaces can be further described or explained by the entire written specification, of which this detailed description is an integral part. Unless otherwise indicated, the drawings are intended to be read (e.g., cross-hatching, arrangement of parts, proportion, debris, etc.) together with the specification, and are to be considered a portion of the entire written description of this invention. As used in the following description, the terms “horizontal”, “vertical”, “left”, “right”, “up” and “down”, as well as adjectival and adverbial derivatives thereof, (e.g., “horizontally,” “rightwardly,” “upwardly”, etc.), simply refer to the orientation of the illustrated structure as the particular drawing figure faces the reader. Similarly, the terms “inwardly” and “outwardly” generally refer to the orientation of a surface relative to its axis of elongation, or of rotation, as appropriate.

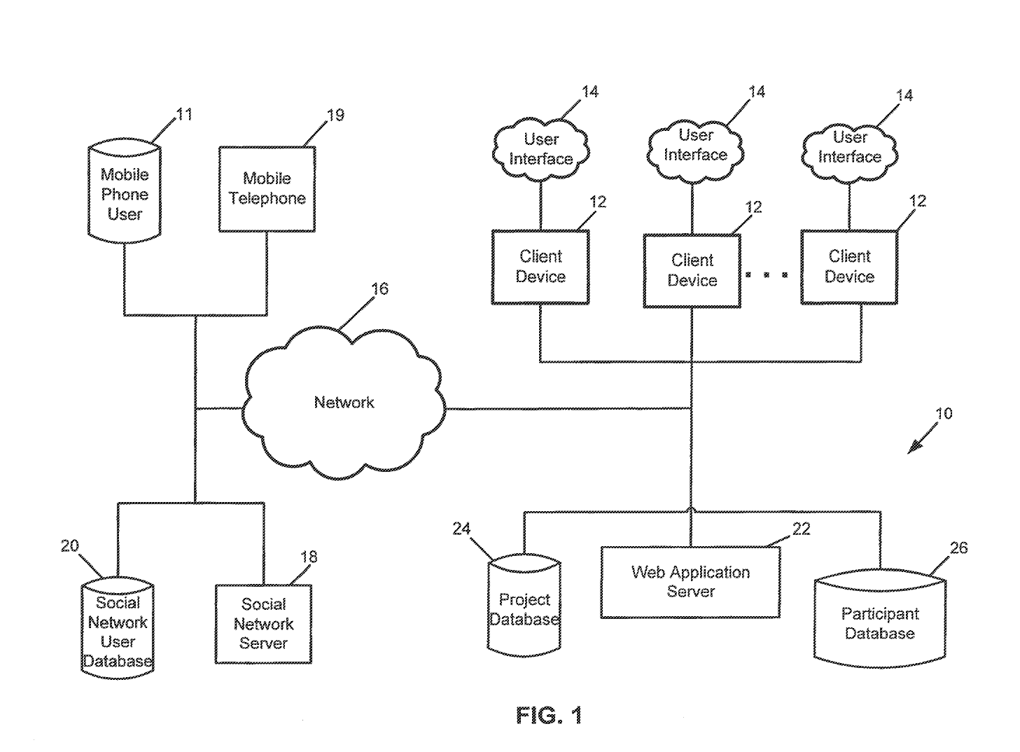

Referring now to the drawings, FIG. 1 illustrates a block diagram 10 of a plurality of processor-based client devices 12 with user interfaces 14, a mobile telephone network server 19, a mobile telephone user database 11, a processor-based web application server 22, a participant database 26, and a project database 24 coupled via a network 16, according to an exemplary embodiment. More than one mobile telephone network server 19 and mobile telephone user database 11 can be coupled to the network 16. Also, more than one processor-based web application server 22, project database 24, and participant database 26 can be coupled to the network 16. Only one of each is shown in FIG. 1 for clarity.

The plurality of processor-based client devices 12 can be any processor-based system, processor-based device, and/or any combination of processor-based devices/systems that are able to establish a connection with another device, a server and/or other systems. Each client device 12 comprises a processor 210, a user display 220, a user input device 230 (e.g., mouse, keyboard, etc.), a memory 240, a storage 250 and a connection facility 260. The user display 220 presents data exchanged between the device and a user. Preferably, the user display 220 can be a touch screen 220 that combines the functionalities of both the user display and the user input device 230, as with a typical smart phone. For example, the client devices 12 can be, but are not limited to, a processor-based server, a processor-based desktop computer, a processor-based computer cluster, a processor-based mobile computing device such as a notebook, a laptop computer, a handheld computer, a mobile phone, a smart phone, or a PDA. In particular, the Google® Android software platform allows developers to write software applications to integrate third party applications with users of mobile devices, and Apple® also allows third party applications developers access to the iPhone® platform. In an exemplary embodiment, the client devices 12 are each coupled to the network 16. In an exemplary embodiment, the client devices 12 can be directly connected to one another.

The network 16, to which the client devices 12 are coupled, can be a telephonic network, an open network, such as the internet, or a private network, such as an intranet and/or the extranet. The network 16 can be any collection of distinct networks operating wholly or partially in conjunction to provide connectivity to the client devices and servers, and can appear as one or more networks to the serviced systems and devices. In an exemplary embodiment, communications can be achieved by a secure communications protocol, such as secure sockets layer (SSL), or transport layer security (TLS). In an exemplary embodiment, communications can be achieved via one or more wireless networks.

The client devices 12 can be coupled to the network, for example, the internet, via a dial-up connection, a digital subscriber loop (DSL, ADSL), cable modem, and/or other types of connection. Thus, the client devices 12 can communicate with processor-based remote servers (e.g., web server, host server, mail server, and instant messaging server) that provide access to user interfaces of the World Wide Web via a web browser, for example.

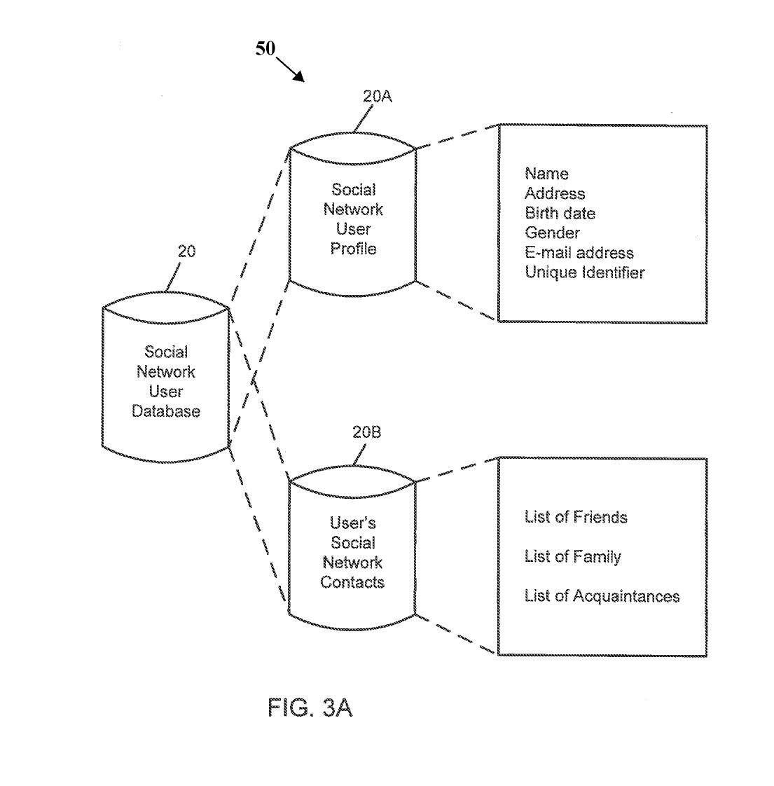

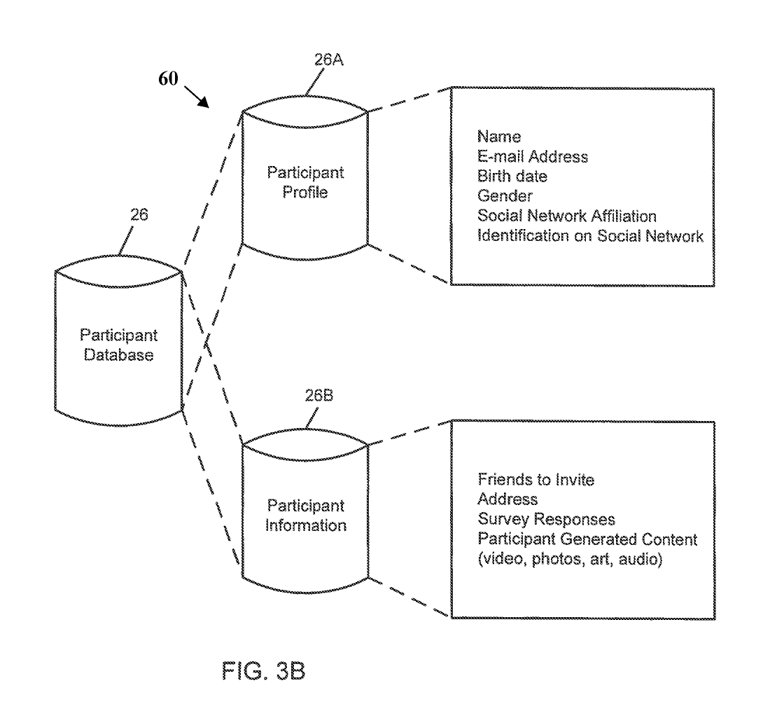

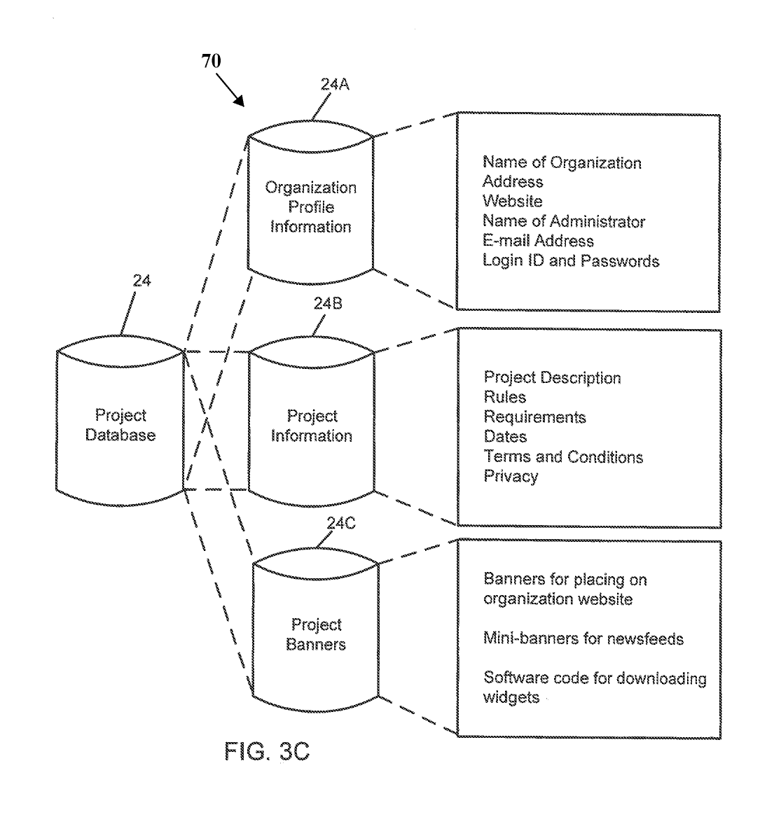

The user databases 11, 20, projects database 24, and participant database 26 can store information such as software, descriptive data, images, system information, drivers, and/or any other data item utilized by parts of the mobile telephone network server 19, and/or the processor-based web application server 22 for operation. User databases 11, 20, projects database 24, and participant database 26 can be managed by a database management system (DBMS), for example but not limited to, Oracle, DB2, Microsoft Access, Microsoft SQL Server, PostgreSQL, MySQL, FileMaker, etc. An example set of data to be stored in the participant database 26 and projects database 24 is further illustrated in FIGS. 3B and 3C.

The mobile telephone network server 19 can be any combination of software agents and/or hardware modules for establishing a mobile telephone network for users. The mobile telephone network server 19 can facilitate interaction and communication among users of the client devices 12, with the processor-based web application server 22, or with other related applications and/or systems via the network 16. For example, the mobile telephone network server 19 can provide a platform for users of the client devices 12 who are members of the mobile telephone network to call or text message other users of the client devices 12. In an exemplary embodiment of the claimed invention, the mobile telephone network server 19 can support web browsing over a mobile telephone.

The processor-based social network server 18 can be any combination of software agents and/or hardware components for establishing a social media-based platform for users. The processor-based social network server 18 can facilitate interaction and communication among users of the client devices 12, with the processor-based web application server 22, or with other related applications and/or systems via the network 16. For example, the processor-based social network server 18 can provide a platform for users of the client devices 12 who are members of the social network to upload photos and notes to share with other users of client devices 12 who are also members of the same social network. In an exemplary embodiment, the processor-based social network server 18 can facilitate sharing of information about news and activities of members of the social network with other members designated as friends within the social network. The functionality of the social media-based platform can also be distributed across multiple servers disposed across the network 16.

The processor based social network server 18, in an exemplary embodiment, is configured to store and retrieve data from the social network user database 20. In an exemplary embodiment, the processor-based social network server 18 is configured to provide data from the social network user database 20 to another authenticated server, such as the processor-based web application server 22 via the network 16. Multiple processor-based social network servers 18 can be coupled to the network 16, with one or more processor-based social network servers 18 providing services for distinct social networks.

The mobile telephone network server 19, in accordance with an exemplary embodiment, is configured to store and retrieve data from the mobile telephone user database 111. In an exemplary embodiment, the processor-based mobile telephone network server 19 is configured to provide data from the mobile telephone user database 20 to another authenticated server, such as the processor-based web application server 22 via the network 16. Multiple processor-based mobile telephone network servers 19 can be coupled to the network 16, with one or more processor-based mobile telephone network servers 19 providing services for distinct mobile telephone networks.

The processor-based web application server 22 can be any combination of software agents and/or hardware components for generating a customized online volunteer service project to be used with a widget, and/or webpage, and/or application to be integrated with one or more social media-based platforms. The application is used with a social media-based platform and allows participants to enter the volunteer service project form from within the social-media based platform.

Alternatively or additionally, the processor web application server 22 can generate a customized mobile telephone volunteer service project application for use in conjunction with a mobile telephone network platform and/or with mobile telephone devices. The mobile telephone application permits a mobile telephone user to view and enter volunteer service projects generated by the processor web application server 22 without having to enter the Internet browser on the mobile telephone to enter the promotion.

The processor-based web application server 22, in accordance with an exemplary embodiment, is configured to communicate with client devices 12 via the network 16 to receive detailed information about the volunteer service project from the service organization's representative through project administration software. The detailed information can be stored and retrieved in the project database 24 via the network 16.

After a customized volunteer service project has been integrated with a project application within a participating social media-based platform and/or a widget and/or a webpage, the processor-based web application server 22, in an exemplary embodiment, can receive registration forms or project entry data from participants. In an exemplary embodiment, a participant can interact with the volunteer service project or enter the service project without submitting a registration form. In accordance with an exemplary embodiment, the processor-based web application server 22 is configured to communicate with the processor-based social network server 18 via the network 16 to receive information about a participant from the participant's social media profile. The registration form data and the information from the participant's social media profile can be stored, subject to a social network's privacy and third-party developer guidelines, in the participant database 26 via the network 16 for later retrieval and analysis.

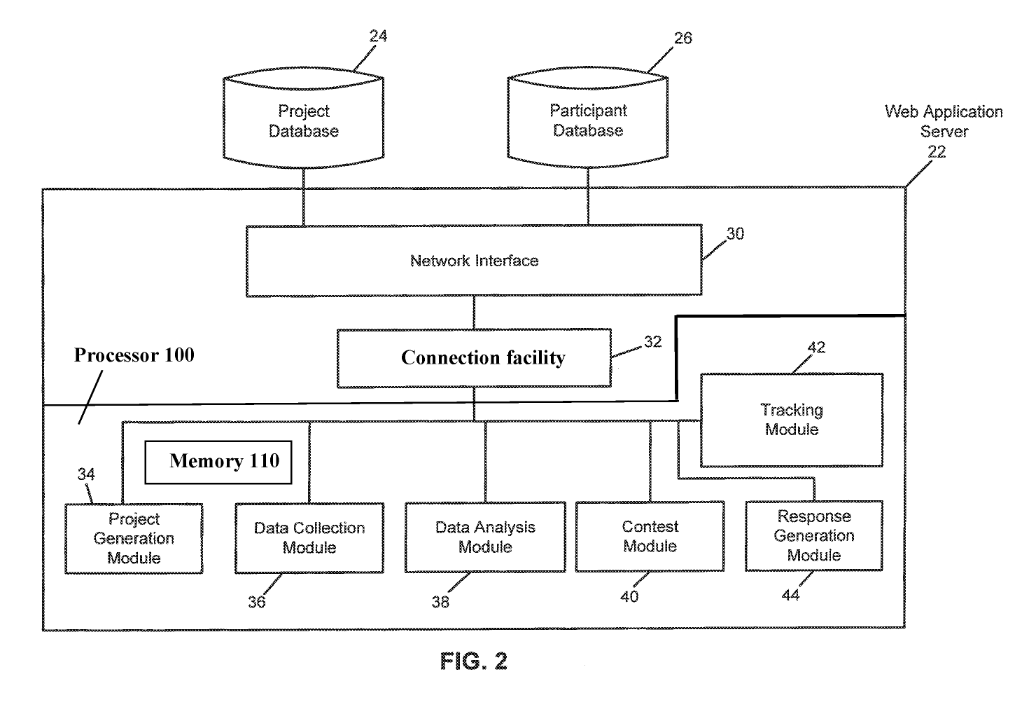

FIG. 2 is a block diagram illustrating a system for providing a customized online volunteer service project through the project administration software and integrating the online volunteer service project with one or more social-media-based platforms and/or mobile telephone network platforms. The system can include a processor-based web application server 22 coupled to a project database 24 and/or a participant database 26, in accordance with an exemplary embodiment.

In the example of FIG. 2, the processor-based web application server 22 includes a network interface 30, a firewall (not shown), a communications or connection facility 32 and a processor 100. The processor 100 comprises a memory 110, a project generation module 34, a data collection module 36, a data analysis module 38, a contest module 40, a tracking module 42 and a reporting module 44. It is appreciated that the processor 100 can comprise additional modules or fewer modules. The processor-based web application server 22 can be communicatively coupled to the project database 24, and/or the participant database 26 as illustrated in FIG. 2. In an exemplary embodiment, the project database 24 and/or the participant database 26 are partially or entirely internal to the processor-based web application server 22.

In the example of FIG. 2, the network interface 30 can comprise one or more networking devices that enable the processor-based web application server 22 to mediate data in a network with an entity that is external to the server, through any communications protocol supported by the server and the external entity. The network interface 30 can include, but is not limited to, one or more of a network adaptor card, wireless network interface card, router, access point, wireless router, switch, multilayer switch, protocol converter, gateway, bridge, bridge router, hub, digital media receiver, and/or repeater.

A firewall, in an exemplary embodiment, can be included to govern and/or manage permission to access data in a computer network, such as promotions database 24 and/or participant database 26, and track varying levels of trust between different machines and/or applications. The firewall may be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall can additionally manage and/or have access to an access control list which details permissions including for example, the access and operation rights of an object by an individual, a machine, and/or an application, and the circumstances under which the permission rights stand.

Other network security functions can be performed or included in the functions of the firewall including, but not limited to, intrusion-prevention, intrusion detection, and personal firewalls. In some embodiments, the functionalities of the network interface 30 and the firewall are partially or wholly combined and the functions of which can be implemented in any combination of software and/or hardware, in part or in whole.

In the example of FIG. 2, the processor-based web application server 22 comprises the communications/connection facility 32 or a combination of communications/connection facilities 32 communicatively coupled to the network interface 30 to manage a one-way, two-way, and/or multi-way communication sessions over a plurality of communications protocols. In an exemplary embodiment, the communications/connection facility 32 receives data, information, commands, requests, and/or text-based messages over a network. In an exemplary embodiment, the communications/connection facility 32 receives communications from a network (e.g., internet, wired and/or wireless network) initiated via a web-interface.

Since the communications/connection facility 32 is typically compatible with receiving and/or interpreting data originating from various communication protocols, the communications/connection facility 32 is configured to establish parallel and/or serial communication sessions with users of remote client devices for data and command exchange (e.g., user information and/or user content).

In addition, the communications/connection facility 32 can manage log-on requests received from one or more users connecting to the processor-based web application server 22 including, but not limited to, generating a new project, entering a project, reviewing participant data for a project, selecting a winner for a contest related to a volunteer service project, and/or providing information to be included with a notification and/or newsletter to be sent to participants of a project. In some instances, authenticated sessions are managed by the communications/connection facility 32 for user logon processes.

For example, the system can utilize a username/email and password identification method for authorizing access. The communications/connection facility 32 may gather data to determine if a user is authorized to access the system and if so, securely logs the user into the system. In accordance with exemplary embodiments, other forms of identity authentication, such as security cards and/or digital certificates may be utilized. A user can specify and/or obtain a logon ID after subscribing or registering.

The communications/connection facility 32 is configured to establish communication sessions with a processor-based social networking server 18 to transmit customized promotion banners and other information for displaying information about a volunteer service project on a webpage within a social networking site or to transmit or receive information about participants.

In an exemplary embodiment of the processor 100 of the processor-based web application server 22 comprises a project generation module 34. The project generation module 34 can be any combination of software agents and/or hardware components able to request and receive detailed information from an organization or company about the volunteer service project to be generated. Based upon the received information, the project generation module 34 generates a customized online promotion to be used with a widget and/or webpage and/or promotion application integrated with one or more social media-based platforms. In an exemplary embodiment, a customized business version of the project application is provided to the administrator of an organization running a volunteer service project for adding to the organization's social media network page in order to display a promotion banner on the organization's social media network page. In an exemplary embodiment, the project application can be used to display a promotion banner on the organization's social network page because the project application is able to distinguish between downloads to a participant social network page and an organization social network page. In an exemplary embodiment, the organization's social network page may be run from a business page of the social network, if the social network provides business pages for organizations.

In an exemplary embodiment, a line of software code can also be provided by the project generation module 34 for pasting into the organization's webpage or other webpages external to participating social media-based platforms. The software code downloads a widget onto the webpage that displays information for advertising the volunteer service project and the organization. The widget integrates the volunteer service project with the viral features of the participating social media-based platforms and accesses the data contained in a participant's social media-based platform profile without requiring participants to migrate away from the widget. The widget may include, but is not limited to, clickable banners, clickable text, and clickable links. Upon clicking on any of the clickable objects, the participant may be provided a volunteer service project registration form or some other way to interact with the project in order to enter the volunteer service project.

In an exemplary embodiment, the organization may be provided with the option to display a clickable banner, button or link on the website(s) instead of a widget. Clicking on the banner, button or link would take a participant to a webpage containing the project registration form.

In an exemplary embodiment, the project generation module 34 provides a listing page within each participating social media-based platform of all currently active volunteer service projects accessible from a webpage within the social media-based platform. In an exemplary embodiment, the listing page only includes projects that have recently been entered by the participant's social network friends. In an exemplary embodiment, the listing page only includes projects that relate to the interests and/or demographic of the participant as determined by the participant's social network profile data. In an exemplary embodiment, the participant can pre-define which types of projects he wishes to appear on the listing page. In an exemplary embodiment, a listing page of all currently active projects is provided on a webpage or webpages external to the participating social media-based platforms.

In an exemplary embodiment, the project generation module 34 can provide a project application to a participant for adding to the participant's social network profile, if the participant has not previously registered for a project through the project application.

In an exemplary embodiment, an online promotion for use with mobile telephones on a mobile telephone network platform may allow a mobile device user to access the volunteer service project in multiple ways. The mobile device user can download to his mobile device a mobile phone project application designed for use with mobile devices, such as an iPhone. Alternatively, the mobile device user can access the device's browser and enter a volunteer service project through the social network of his choice or the website of the organization offering the project or another website external to the participating social media-based platforms. In both situations, the viral features of the social network or networks associated with the project are available to increase awareness of the project and the organization.

In an exemplary embodiment, the mobile telephone promotion application allows location specific projects to be offered. For example, if a mobile phone user is in proximity to a business running a volunteer service project, the user receives an alert inviting the user to register for the project.

In an exemplary embodiment, the mobile telephone project application may access global positioning system (GPS) data provided by a participant's mobile telephone. The GPS data can be used in conjunction with an organization's volunteer service project. For example, the GPS data may be used to determine the eligibility of a participant for a project. For example, if a participant is located within a predetermined area within a certain time window, the participant would be eligible for a project. Alternatively or additionally, the GPS data can be used to evaluate a participant, for example, measuring how quickly a participant completes a project that requires participants to visit certain points in a city or region. In an exemplary embodiment, the GPS data can be used in the generation of activity feeds (such as newsfeeds and mini-feeds) that display information about participants' interactions with projects that are being run using the mobile telephone project application. For example, when a participant enters a site where a volunteer service project is being conducted, a newsfeed may be generated in the participating social network based platforms. In an exemplary embodiment, the GPS data can also be used by the mobile telephone promotion application to enable a participant to interact with the project.

In an exemplary embodiment, the project generation module 34 provides for establishing competitions between participants where participants can earn points/rewards based on their efforts on service projects. The participants can earn badges, move up levels, and compete with their friends to have the largest impact in their communities. The competitions are social media empowered through sharing among online channels and friends through the interaction with the processor-based social network server 18 via the network 16 as described in detail herein.

In an exemplary embodiment, the project generation module 34 calculates credits e.g., “clean credits” for an environmentally based service project. The “clean credit system” assigns a base score to various volunteer activities in the environmental sector. This score is a measured impact based on environmental data for the country.

In an exemplary embodiment, “clean credits” or CLEANCREDS may comprise a currency that is earned from volunteer service and community impact. Contrary to traditional loyalty and rewards programs that provide value in return for monetary purchases, the participants in volunteer service projects can earn rewards based on the volunteer hours they donate to their community and the level of impact. The rewards may take the form of gift cards/brand credits and or prizes such as electronics, mentorship opportunities or the like. Participating corporate sponsors may also provide discounts or other rewards to be distributed through the system.

In accordance with an exemplary embodiment, the processor 100 of the processor-based web application server 22 comprises a data collection module 36. The data collection module 36 can be any combination of software agents and/or hardware components able to generate project registration forms for a participant and to receive completed project registration forms from participants, through the communications/connection facility 32. The project registration form can advertise the project and allow the participant to interact with the project by entering the project and/or providing required information prior to registering for the project.

In an exemplary embodiment, the data collection module 36 provides a method to advertise the project and for the participant to interact with the project without the explicit use of project registration forms. For example, the data collection module 36 may collect data from participants through questions used in part of a quiz promotion.

In an exemplary embodiment, a participant is advised by the data collection module 36 that by downloading the project application, the participant grants the processor-based web application server 22 permission to access the participant's unique identifier within the social network or the mobile telephone network, and also accepts the terms of entering a project. Access to a participant's unique identifier enables the processor-based web application server 22 to send targeted information relating to the project or the organization running the project to the participant through the processor-based social network server 18. Terms for entering a project may include agreeing to receive unsolicited information, for example, a newsletter sent by either the web application server 22 or the organization running the project. Alternatively or additionally, the terms for entering a project may include the participant's permission for the organization running the project to use the information provided by the participant to promote other goods or services that may or may not be related to the underlying project or to promote other related business activities of the organization. In an exemplary embodiment, if an organization is promoting a third-party organization's goods and/or services, the terms for entering a project may include the participant's permission for the third-party organization to use information provided by the participant for related business activities.

In an exemplary embodiment, the processor 100 of the processor-based web application server 22 comprises a data analysis module 38. The data analysis module 38 can be any combination of software agents and/or hardware components able to analyze the data collected from participants in a particular project through the participants' project registration forms or other forms of data resulting from participants' interaction with the project. The data analysis module 38 can generate data that include, but are not limited to, date and time of registration, unique identifiers of participants, participant information, such as email address or date of birth, and a demographic breakdown of participants by age, gender, zip code, the average age of participants, etc. The data analysis module 38 can generate information about the types of contests, prizes, or rewards that generated the greatest number of registrations for service projects, for example sporting event tickets. In an exemplary embodiment, the data analysis module 38 can provide names and/or unique identifiers of participants who invited the largest number of friends to enter the service project and/or names of participants whose friend invites ultimately resulted in the greatest total number of people who registered for the project. In an exemplary embodiment, the data may be numerical, graphical, or both.

The data analysis module 38, through communications with the communications/connection facility 32, can make the data available to an organization running the project at a particular secured website and may also provide the analyzed data in a downloadable format, for example in an Excel spreadsheet. Alternatively or additionally, the data may be sent to the organization in an email through the communications/connection facility 32.

In an exemplary embodiment, the data analysis module 38 can verify one or more of the data provided by participants in the registration form or during interaction with the project. In one non-limiting example, a participant can be required to be at least 18 years old and/or from a specific country, state or location before participating in a particular project. Thus, the participant's age and/or geography can be verified prior to permitting the participant to enter the project. In another non-limiting example, a participant's email address or other entry information can be verified before permitting the participant to enter the project or if a participant is selected as a winner, the participant's email address or other entry information can be confirmed prior to awarding of the prize.

In an exemplary embodiment, the processor 100 of the processor-based web application server 22 comprises a contest module 40. The contest module 40 can be any combination of software agents and/or hardware components able to calculate the winner of contests, as specified by the project rules. Alternatively, the contest module 40 can select a winner according to other criteria specified by the rules of the project. An organization can elect not to use the contest module 40 to select a winner. The organization can choose to select its own winner, for example, based upon subjective criteria such as the participant that most impressed the staff of the organization hosting the project. If the organization selects the winner, the organization submits the name of the winner or winners to the contest module 40. Alternatively, submission of entries that are subjectively evaluated can be thrown open to judging by members of the social network. For example, each member of the social network may be permitted to vote a maximum number of times during the project or a maximum number of times per day for a preferred participant, and the winning participant is the one that garners the greatest total number of votes at the close of the project. By integrating user voting within the social media-based platform, viral features, such as newsfeeds and mini-feeds, further spread the word about the project.

In another example, members of a social network could vote for their favorite volunteer service project, and the act of voting would generate a newsfeed that included, but is not limited to, the name of the person, the name of the service project that the person voted for, and the name of the organization sponsoring the project. In addition, a video from the project may be embedded in the newsfeed.

Once a winner is selected, whether by the contest module 40, by the organization running the project, by voting, or by another method, the contest module 40, through the communications/connection facility 32, notifies all the participants who entered the project of the identity of the winner or winners. Notification may be by email or through custom messages directed to the social network inbox of all participants.

In an exemplary embodiment, the processor 100 of the processor-based web application server 22 comprises a tracking module 42. The tracking module 42 can be any combination of software agents and/or hardware components able to receive input from a wireless tracking system such as a QR code reader on the site of the volunteer service project. The volunteer tracking and verification of actions can be based on QR codes or the like. The tracking module 42 calculates the time spent on a project and converts the hours into a measure of the impact that the service had on the community. In the case of environmental projects, environmental data for the country is used to calculate a “clean credit” based on the number of hours and the environmental data related to the activity and its impact on the environment. The tracking module 42 allows organizations to obtain tentative sign ups/numbers of volunteers and participants in their programs. The tracking module 42 allows for tracking volunteer turnout and analyze registration numbers versus actual turnout.

In an exemplary embodiment, the processor 100 of the processor-based web application server 22 comprises a reporting module 44 that can be any combination of software agents and/or hardware components able to generate reports with all volunteer activities including time spent on the activities, credits related to the impact of the activities, and volunteer hours per challenge. The reporting module 44 provides records that can be printed by a participant and submitted to their school for graduation volunteer hour requirements. These records are automatically verified by the host organizations through the system. In another aspect of the reporting module 44, the reporting module 44 receives feedback, reviews or comments from the participants upon check out/completion of the volunteer activity and generate a report for the organization based on this data.

FIG. 3A depicts a block diagram 50 illustrating an example of a social network user database 20 that stores social network user profile information 20A and the user's social network contact information 20B, according to an exemplary embodiment.

In the example of FIG. 3A, the social network user profile database 20A can store user profile data, including descriptive data of personal information such as, but not limited to, a first name and last name of the user, a valid email address, a unique user identifier within the social network, birth date, gender, occupation, etc. User profile data can further include interest information, which can include, but is not limited to, activities, hobbies, photos, etc. In an exemplary embodiment, the social network server 18 can store the information in the social network user database 20, and the processor-based web application server 22 can be permitted to access information in the social network user database 20 if the user grants permission. The database 20 can also store a user's social network contacts, for example, in database 20B. A user's social network contacts can be provided via one or more software agents and/or hardware modules coupled to the database 20B. For example, a user can invite a member of the social network to become a friend, and the invited member may become listed as such in the user's list of social network contacts if the invited member agrees.

A mobile telephone user database 11 for a mobile telephone network stores information similar to that of the social network user profile 20A portion of the social network user database 20, such as name, address, and mobile telephone number.

FIG. 3B depicts a block diagram 60 illustrating an example of a participant database 26 that stores participant profile information 26A and a participant's survey responses 26B, according to an exemplary embodiment of the claimed invention.

In the example of FIG. 3B, a participant's profile information is stored in database 26A. Participant profile information includes descriptive data of personal information such as, but not limited to, a first name and last name of the user, a valid email address, birth date, gender, zip code, one or more social network affiliations and/or mobile telephone network affiliation, and a unique identifier on the one or more social networks and/or mobile telephone network the participant is affiliated with, etc.

The database 26 can also store a participant's responses to surveys and/or requests to invite friends, for example, in database 26B. A prerequisite to being entered in a volunteer service project can be for a user to complete a survey provided by the administrator of the project. Survey questions can include, but are not limited to, providing a name, an email address, demographic information, an address for receiving free samples and/or promotion materials and preference for joining a mailing list. In an exemplary embodiment, survey questions can include the option of electing to join one or more groups associated with the one or more social media-based platforms and the organization or a third-party organization. For example, a participant can be given the opportunity to click a button or a link in order to become a fan of the organization's Facebook page, and the organization is then permitted to send messages via the Facebook platform to this participant so long as the participant remains a fan. In an exemplary embodiment, clicking on a link or a button or checking a box to elect to become a member of a group associated with an organization will automatically result in the participant becoming a member. Alternatively, clicking on a link or button or checking a box to elect to become a member of a group associated with an organization will trigger a pop-up window or a new browser window to open where the participant can take action to become a member of a group. Upon submission of a service project registration form, the participant is shown a webpage listing the names of the participant's social network friends, and she can select friends to invite to enter the project. An organization can provide an incentive to participants for inviting friends by, for example, increasing the participant's chances of winning for each friend that is invited or for each invited friend that subsequently enters the volunteer service project.

FIG. 3C depicts a block diagram 70 illustrating an example of a project database 24 that receives project information, according to an exemplary embodiment.

In the example of FIG. 3C, the profile information for an organization submitting a promotion is stored in database 24A. Organization profile information includes, but is not limited to, the name of the organization, address of the organization, a website address for the organization, names for one or more administrators within the organization, an email address for one of the administrators of the promotion, login identification, and passwords.

The project database 24 can also store promotion information in database 24B. Project information can include, but is not limited to, descriptions of the project, value of the measured impact of the project, requirements to enter the project, survey questions, the active dates for the project, terms and conditions, and the privacy policy of the organization with respect to information collected from participants.

The project database 24 can also store banners and widgets associated with a project in database 24C. Types of banners include, but are not limited to, banners for placing on an organization's website to advertise the organization's project, interactive widgets, mini-banners displayed in newsfeeds generated by the processor-based social network server 18 that advertise the project, and banners for displaying to a participant after the participant submits her registration to the project. In an exemplary embodiment, banners can be any size including, but not limited to, standard banner sizes, oriented horizontally, or oriented vertically.

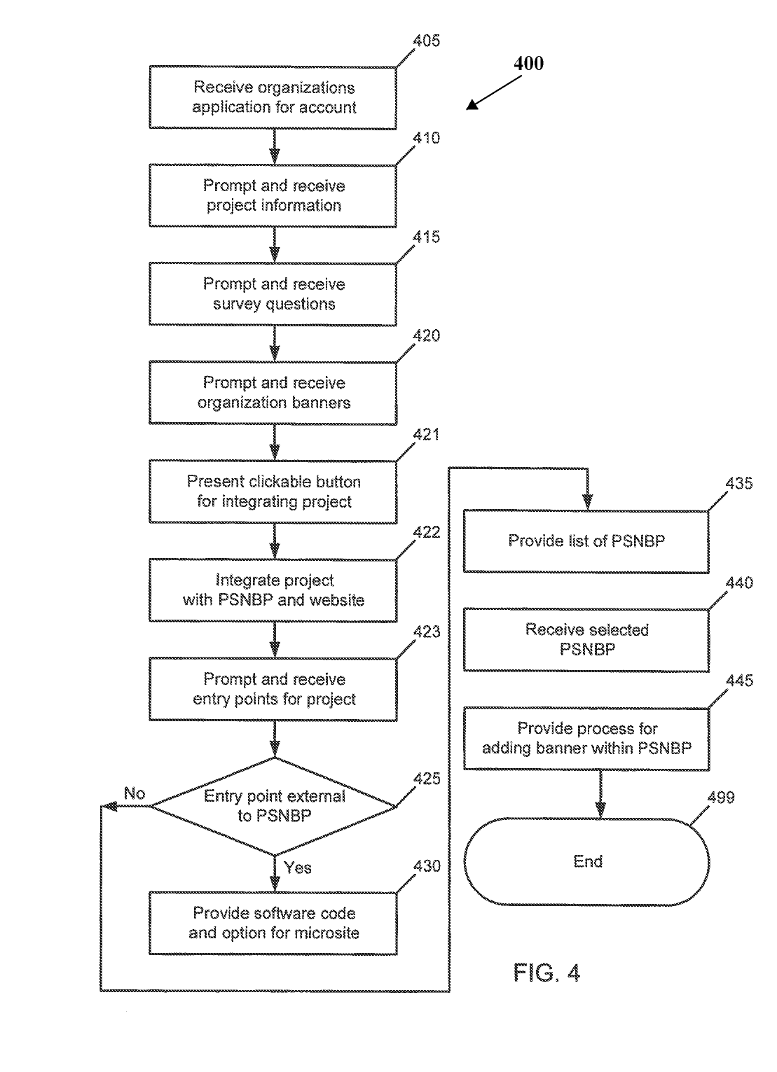

FIG. 4 depicts a flow diagram 400 illustrating an example process of establishing a volunteer service project with the processor-based web application server, according to an exemplary embodiment of the claimed invention. Prior to permitting a company or organization to solicit participation in a volunteer project, the company or organization must first create an account with the web application server by transmitting account information to the system, preferably through a website, but mailed-in or faxed applications can also be used for creating an account on the system. The system receives the account information at block 405. Account information can include, but is not limited to, the organization's name, people permitted access to the company account, a billing address and billing information, such as a credit card number or billing authorization information. The organization is either assigned a login name and password, or the organization's representative can choose them. By providing the correct login information for an organization, the organization's representative is permitted to access the information for each project that the organization has created. After creating an account, at block 410, the organization's representative is prompted online by project administration software for information to set up the organization's project. A project can include, but is not limited to, environmental or social service projects.

After submission of the promotion information, at block 415, the organization's representative is prompted to define survey questions and/or text to be included in a customized registration form to be presented to a potential participant. Survey questions can include, but are not limited to, name, address, email address, interests, hobbies, vocation, etc. In an exemplary embodiment, questions include data used by an organization for marketing, branding, and/or future product line decisions. The system receives this information at block 415.

At block 420, the company is prompted to upload to the system a customized banner(s) or other design work for the project. Alternatively, template banner designs can be offered to the company for selection. Banners can be used to advertise the project and/or the brand of the organization sponsoring the project. Several types of banners can be uploaded, including but not limited to, a banner to place on the organization's social network webpage or company webpage, on other webpages within or external to a participating social media-based platform, or on a promotion widget on webpages within or external to participating social media-based platforms to advertise the project; mini-banners that can be displayed with newsfeeds, mini-feeds and other similar user activity display features that are automatically generated when a user registers for a volunteer service project. Banners are clickable and may direct a participant to a project registration form or other entry point for interacting with a project. Alternatively, banners displayed after the participant has entered the project may direct the participant back to the organization's website or social network page. The system receives the banners and/or banner selections from the organization at block 420.

At block 421, the organization is presented with a clickable button for integrating its project with the project application in the participating social media-based platforms. Clicking this button will result in the integration of the project with the project application in all participating social media-based platforms (PSNBP) and the organization's own website at block 422. In fact, participants can click a different button for each social network that they want their project campaign to display on. Participating social media-based platforms are those social media-based platforms that are willing to support the project application and for which software is available to integrate the project application with the particular social media-based platform. Examples of online social media-based platforms that may participate include Facebook™, MySpace™, Bebo™, Orkut™, and Friendster™. Integrating a project with the project application within a participating social media-based platform enables participants to enter and interact with the project within a social network upon clicking a link to the project, such as found in a newsfeed or friend invite, for example. It should be noted that the organization does not need to maintain a webpage on a particular social media-based platform in order to have the project integrated with that platform. In an exemplary embodiment, integrating a project enables the project to be integrated with the viral features of a social network. In an exemplary embodiment, it enables the project to be included in the project listings page which is provided by the project application in each of the participating social media-based platforms and displays all projects currently integrated with the project application. In an exemplary embodiment, the project applications' listing page of a given social media-based platform is presented to a project participant after completion of the registration process for a project so that the participant may find other projects of interest to participate in.

In an exemplary embodiment, an organization can choose which participating social media-based platforms they would like to integrate their project with rather than automatically having their project integrated with all participating social media-based platforms.

At block 423, the organization is prompted to select where it would like to locate the entry point or entry points for its project. It can choose to locate the entry point(s) on one or more webpages external to the participating social media-based platforms or on one or more webpages within the participating social networks. The system receives the entry point information from the organization at block 423.

When the chosen entry point is a webpage external to the participating social media-based platforms, a participant interacts with a widget that advertises the project on the website(s). The participant clicks on the widget to register for the project, and the widget displays the project registration form. The widget integrates the project with the viral features of the participating social media-based platforms and accesses the data contained in a participant's social media-based platform profile without requiring participants to migrate away from the widget. In an exemplary embodiment, clicking on the widget enables the participant to interact with the project (e.g. play a game, enter a quiz, upload a video) before the participant is required to complete the registration form. In an exemplary embodiment the participant can interact with the project without completing a registration form. Upon completing the entry form or the project registration process through the widget, the participant is directed to invite friends to the project by using one of two methods. The participant may select friends from his social network friends list which is connected to the widget via services such as Google™ FriendConnect™ Facebook™, FacebookConnect™ MySpace™, DataAvailability™ project and other similar services that enable third-party applications or websites external to social networks to access a user's data and friends list contained within social networks, and to transmit users' activity information back to the newsfeeds, mini-feeds and other such activity feeds contained within social networks. Alternatively or additionally, the participant can type in friends' email addresses or select friends from his email address book which the participant can download into the widget from such email service providers as Gmail™, Hotmail™ and Yahoo Mail™.

In an exemplary embodiment the participant interacts with the project via an interactive webpage or webpages instead of a widget. The interactive webpage or webpages provide an entry form for the project and enable the participant to interact with the project. By connecting with services such as Google™, FriendConnect™, Facebook™, FacebookConnect™, MySpace™, DataAvailability™ project and other similar services, the interactive webpage or webpages integrate the project with the viral features of the participating social media-based platforms and access the data contained in a participant's social media-based platform profile without requiring participants to migrate away from the interactive webpage or webpages. In an exemplary embodiment, the participant can click on a banner, button, or link that takes the participant to the interactive webpage or webpages for registering and interacting with the project. In an exemplary embodiment, the banner, button, or link can be located on an organization's website which advertises the project; a participant who clicks on one of these objects will be taken to the interactive webpage or webpages where she can enter and/or interact with the project. In an exemplary embodiment, the interactive webpage or webpages can be hosted by the processor-based web application server 22.

In an exemplary embodiment, an organization can choose to use a webpage dedicated to the entry process for their project, rather than a widget, because the widget cannot provide sufficient graphics or other text, as desired by the organization to advertise the project. In an exemplary embodiment, an organization can select the widget because of its compact size and ability to enable a participant to interact with and/or register for a project without the participant needing to migrate away from the webpage upon which the widget is displayed, for example, the organization's webpage.

When the chosen entry point is on the organization's social network webpage or other webpage within one of the participating social media-based platforms, a participant clicks on a banner, widget, or link that advertises the project on the particular webpage, and the participant is directed to add the project application to the participant's social network profile. Alternatively, the participant can click on a banner, a link in a newsfeed or mini-feed, a link in a friend invitation, or any link to the project generated by a viral feature of the social media-based platform, and the participant will be directed to add the project application to the participant's social network profile. In an exemplary embodiment, the participant can click on the banner, widget, or link and directly register for the project without downloading the project application to his social network profile.

At decision block 425, the system determines if the organization has chosen to have an entry point to the project on a webpage external to the participating social media-based platforms. If the organization chooses to establish an entry point for the project on a webpage or webpages external to the participating social media-based platforms (block 425—Yes), at block 430, the system provides software code, such as HTML or Javascript code, that may be copied and pasted into a webpage or webpages. The organization is also provided the option of publishing its project via a microsite linked to the organization's webpage or webpages. For the first option, the software code displays a widget on the webpage(s); the widget advertises the promotion and enables a participant to interact with and register for the project, thus the widget functions as an entry point to the project. In an exemplary embodiment the organization can select from a variety of widget templates that offer different design, layout and color options. Each template has its own unique software code that the organization can copy and paste into a website(s) to display the widget. In an exemplary embodiment, the organization can be provided with the option to display a clickable banner, button, or link on the webpage(s) instead of a widget. Clicking on the banner, button, or link would take a participant to a webpage containing the project registration form.

For the microsite option, the organization representative does not need to paste code into a webpage. The project administration software permits the representative to simply click on an appropriate button that triggers publication of the organization's microsite.

The process continues to block 435 where the system presents a list of the participating social media-based platforms with which the organization's project has been integrated. The system also provides links corresponding to these participating social media-based platforms to which the organization can, if it wishes, add a project banner/entry point to particular webpages within those participating social networks. The webpages can be those that the organization maintains within the selected social media-based platforms. Alternatively or additionally, the webpages can also be maintained by entities other than the organization that permit the organization to insert project banners/entry points. The system receives the selected social media-based platforms at block 440.

In an exemplary embodiment, regardless of whether the organization chooses to add a project banner/entry point to particular webpages within the participating social media-based platforms, the project application will list the organization's project on a project listing page, with a clickable link, within the participating social network based platforms. In an exemplary embodiment, the organization's project will also be listed on a project listing webpage that is external to the participating social media-based platforms. Thus, a participant can easily find and register for the project without having to go to a particular organization's webpage.

At block 445, the system provides the organization with two options for integrating a project with a social media-based platform. For the first option, a banner is added to the webpages of the specified social media-based platforms. The details for publishing a banner on webpages within different social media-based platforms can vary. However, as an example, the process for publishing a project banner on the organization's Facebook™ webpage(s) will be described. Clicking on the Facebook™ link provided at block 435 takes the organization's representative to a Facebook™ page where the representative can click on a link to download the project application for publishing project banners within Facebook™.” Because the application is downloaded to a business page on Facebook™, the project application recognizes that the user is an organization and provides customized features for business users. In an exemplary embodiment, the organization downloads a customized business version of the project application. The organization is then prompted to provide its log-in information supplied to the project administration software that it previously established at block 405. After inputting the log-in information, the organization is taken to a webpage where the organization's projects that are integrated with the project application in Facebook™ are listed. A banner publication button is displayed next to each project which, when clicked, will add the banner for that project to the organization's Facebook™ page(s). The process ends at block 499, and at this point the project is ready to be entered from the organization's social network page and/or a webpage external to the participating social networks. Alternatively, the start of the project can be delayed until a specific date received by the system at block 410.

For the second option, the organization can create a dedicated tab within the organization's social network page within which they can publish one or more projects, such as provided for by the social network Facebook™.

In an exemplary embodiment, a project banner can be added to a webpage within a participating social media-based platform that is not controlled by the organization running the project, if the controller of the webpage agrees. For the example Facebook™ platform, the controller of the webpage would download the project application from within Facebook™ first and then go through a similar process as described above for adding a banner for the project to the webpage.

In an exemplary embodiment, an organization can paste the software code for displaying a widget on one or more webpages within a participating social media-based platform if the platform permits pasting software code for widgets, for example the MySpace™ platform.

If the organization chooses not to publish the project on its own webpage or another webpage external to the social media-based platforms (block 425—No), the process continues at block 435 as described above.

In an exemplary embodiment, the system can provide challenge reminders and integrate dates for challenges/service projects directly into a participant's calendar on their mobile device such as a smart phone.

In an exemplary embodiment, the system can offer an exclusive challenge that may limit the number of participants or can be only offered to participants having exemplary volunteer records or that have achieved certain levels of volunteer service.

In an exemplary embodiment, the host organizations can automatically retrieve emergency contacts/profiles for participants registered for a project.

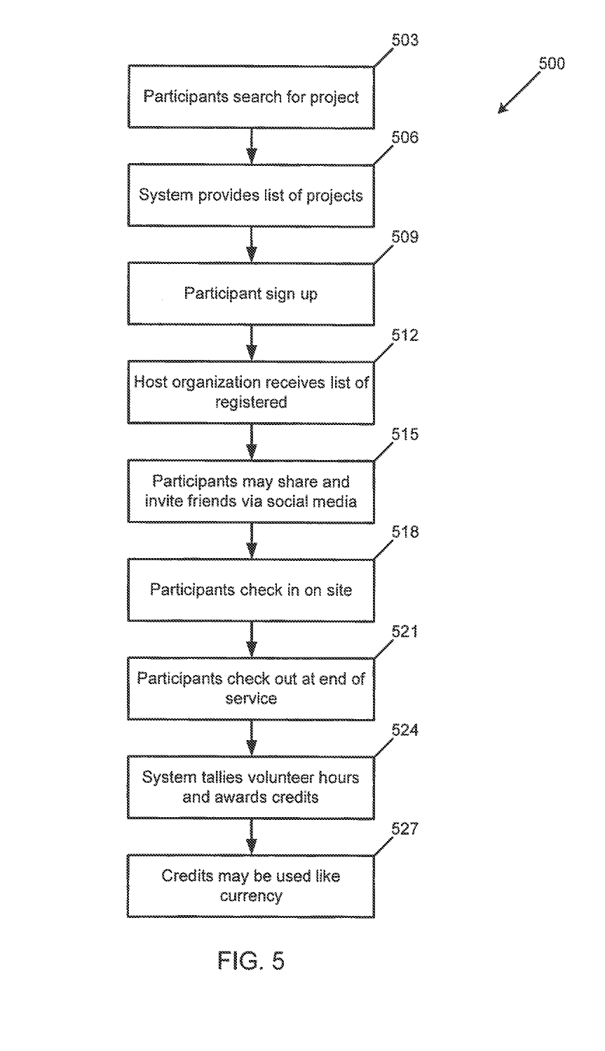

FIG. 5 depicts a flow diagram illustrating a sample operation of the system. In block 503 the participants may search for volunteer “challenges” a.k.a. volunteer activities/existing programs of local nonprofits or organizations. Through GPS technology in block 506, the system provides the participant with a list of volunteer service projects within geographic proximity of the participants current location. In block 509, the participant can sign up through an application on their client device or they can sign up through the system website. The challenge/volunteer service project is added to their profile. In block 512, the host organization receives a list of all of the participants that have registered for their program/activity. Once they have registered, in block 515 the participants can share via social media and their profile to invite friends to join them in the activity. In block 518, on the day of the event the participants automatically check in and in block 521 check out by scanning OR codes with their client devices at the project location. In block 524, after they have checked out of the activity, the system automatically tallies their volunteer hours and they receive “clean credit” scores based on the impact of the activity multiplied by their hours. In block 527, the “clean credits” or CLEANCREDS can be used like a currency to be redeemed for rewards from corporate sponsors.

The volunteer tracking and verification of actions can be based on QR codes or the like. In an exemplary embodiment, the participants have individual member ID's/QR codes and when they arrive at the event, the host organization scans their QR code. The challenge clock starts and the hours that the participant is volunteering are tracked. When the participant is finished, the host scans their QR code on their way out and the system stops the clock and the total volunteer hours are recorded.

In an exemplary embodiment, each challenge is assigned its own unique QR codes with one code for checking into an activity and the other code for checking out of the activity. Organizations can print their codes and place them in a location on site so that the participants can use their mobile devices to scan the check in code on the way into the activity and scan the check-out code on the way out of the activity. Once the participant scans the check-out code, the clock stops and the volunteer hours are recorded.

In an exemplary embodiment, the organization can automatically start and stop the clock at set times for all of the devices within the project site without recording individual times.

In accordance with an exemplary embodiment of the claimed invention, the processor 100 of the processor-based web application server 22 automatically populates a user's online profile in real-time or automatically generates user's “live/living” resume in real-time. As volunteer/user performs social and/or environment service, the processor 100 in communication with the processor 210 of the client device associated with the user automatically populates and updates the user's “live/living” resume or real-time resume to reflect user's actions, work experiences and skills in real-time. That is, the processor 100 populates/builds/generates an online profile without the user having to add information themselves (i.e., no self-reporting or posting is required).

In accordance with an exemplary embodiment of the claimed invention, the living resume generation and volunteer hour tracking can be used to supplement or support extracurricular report cards, volunteer hour time logs, student achievement records, professional profiles and community leadership profiles, charitable project portfolios, and socio-economic impact assessments. The processor-based web application server 22 provides verification of volunteer contributions, demonstration of academic and professional skill development and measurement of positive community impact using impact assessment surveys and computer software tools such as a mobile application, database and computer network that records completion of volunteer activities and socially conscious actions.

The processor 210 executing the mobile app and/or user/web interface 14 in conjunction with the processor-based web application server 22 can verify the completion of actions by the volunteer/user, and automatically document such actions onto an online profile to be shared. The processor 100 can generate detailed time-logs, participation logs, and action reports that can be printed and/or submitted for recognition, acknowledgment and credit from employers, education institutions and so forth.

By scanning of the code, e.g., OR code of the organization or the event using the user's client device 12, the mobile app running on the user's client device can confirm the location and user presence with organizations and/or participation in events. Participation/actions can include showing up to a venue/specific location, donating an item and/or completing a desired physical action.

In accordance with the claimed invention, the processor-based web application server 22 and the user's client device 12 perform a double verification/exchange of data on behalf of the user associated with the client device 12 and a “host/facilitator” (e.g. an organization). That is, the user does not self-report on her actions, the processor 210 verifies the user's actions from an activation from a host of the action via mobile scan, member ID card scan, or check-in through system provider's web interface. Both the user and the host receive real-time updates of the action. The host can export time logs of user participation, contributions and actions, while the user can access their own reports as they need. The interaction between the user and host provides authentic data records by reducing the risk of self-reporting errors and user forgery.

In accordance with an exemplary embodiment of the claimed invention, host organizations post actions using their client devices 12, which can include but are not limited to volunteer, leadership, training, fundraising and learning activities, local events, and skill development opportunities. When a host posts an action, the processor 100 assesses the action on a variety of social impact criteria and leadership requirements. This includes the measure positive outcomes that will result from a user's participation and the skills required/developed by a user.

In accordance with an exemplary embodiment of the claimed invention, users, using their client devices 12, search for actions based on location, cause interests, associated skills, type and interests. A user can elect to sign up for an action of interest via the user interface 14. In response to the user selection/election, the processor 100 adds the user to the participant list for the host organization

On the day of user's selected action, the user checks in via one of four methods: a) the user presents her member code using the mobile app running on her client device 12 to a representative of the host organization and the user's member code is scanned using the host organization's client device 12; b) the user presents a printed member card with her member code to be scanned by the host organization's client device 12; c) the user scans a printed code provided by the host organization using her client device 12; and d) the host organization check the user in and confirms her presence from the participant list accessible via the mobile app or web interface on the host organization's client device 12.

Once the user is checked in, the processor-based web application server 22 in communication with the user's client device 12 and/or host organization's client device 12 automatically tracks the time the user participates in the selected action. This time is added the skill development and impact records already assigned by the system 10 to the action from the initial assessment completed when the action was posted by the host organization.

When the user is finished with her selected action, the user is checked out using one of the same four methods described herein. The system 10 stops her time clock and time-stamps the completion of her selected action to verify her participation. The combined contributions, time, skills, participation and overall completion of a user's actions is recorded on her user profile and added to her account.

Based on these actions, the processor 100 generates and shows in a live activity feed that shows a user's profile, which can be accessed via web browser or mobile app operating on the client device 12. The processor 100 extracts the skill development and associated impact data the user's actions and displayed separately on the user's profile to generate a real-time/live view of user's experience and aptitudes across a variety of criteria. The processor 100 further adds the actions to a detailed action report that the user can print and provide to her employer, academic institutions and other entities.

In accordance with an exemplary embodiment of the claimed invention, the system 10 tracks/documents/logs/confirms physical donations, monetary or material items such as clothing, recycling, hygiene items or anything an organization is collecting. The system 10 digitally tracks/documents/confirms physical donations other than manually reporting, there is currently no solution for organizations to track, for example, the number of food cans are donated, items recycled or amount of money, i.e., number of dollar bills, collected in person at a fundraiser BBQ, etc. The organization can use mobile scanning or digital codes, i.e., printed QR codes via the user's and/or the organization's client devices 12 to register/confirm/document the user donations on the spot, i.e., in real-time. That is, the host “checks-in” or automatically logs the donation to the system 10 using the mobile appl running on their client devices 12 or by scanning a printed digital code. The processor 100 also associates the donation to the account of both the user and the host.

In accordance with an exemplary embodiment of the claimed invention, the system 10 can be used as a resume screening tool to evaluate or determine a user's or candidate's social engagement, measure impact, leadership effect and verified skills. In addition or alternatively, the resume screening tool can be used to evaluate or determine a user's or candidate's leadership, skill development, and experience beyond documented professional work experience. The system 10 tracks, records, compiles, generates and shares a professional profile embodying the work experience and skills that a candidate has achieved outside of the traditional workplace or classroom setting. Such profile can feature: a candidate's community actions and leadership including but not limited to: a) her volunteer work, fundraising contributions, event participation, extracurricular activities and personal development/training/skill learning; b) the measured social impact and effect of a candidate's actions including but not limited to volunteer hours, dollars raised, people helped, jobs created, donations collected, items recycled, healthy actions taken and skills developed; c) a leadership score/rating based on calculation from a user's level of engagement, demonstrated skill, commitment and positive social impact; d) top verified skills developed/shown/demonstrated through her recorded actions; e) top causes supported and personal values/community interests (i.e. insights into her personal motives); f) recommendations received from organizations she has worked with; g) a list of her community network including charity/nonprofit organizations, affiliations and memberships she has supported/been a part of; h) a live feed/stream of latest actions and leadership experience (i.e. a real-time feed of her most recent contributions and activities); and i) regular profile features such as a user bio, location, social network accounts, website, and work portfolio.

In accordance with an exemplary embodiment of the claimed invention, the system 10 provides a web based resume analysis, scoring and ranking focused on positive community impact, volunteer contributions and leadership experiences. User actions are recorded/verified by the processor 100 via the mobile app and/or web interface on the client device 12. When a user engages in an action, the processor 100 tracks her presence, length of time spent, frequency, contributions and skill development on the spot, i.e., in real-time. The processor 100 logs the user's participation with her total cumulative engagement (time), contributions and measured impact when the user finishes her Action their participation, and automatically adds to her impact resume (i.e., user's resume profile). In addition, the processor 100 populates and updates user's impact meters, top skills, causes and organization networks in real-time based on the user's actions as the user engages/participates in more actions. It is appreciated that the user can share her profile with other users, organizations, employers, educators and other entities as. The recipient can access the system 10 to print the user action report that logs every action and contribution that the user made and tracked by the system 10.

In accordance with an exemplary embodiment of the claimed invention, the system 10 provides a skill tracking tool that verifies applied skills and/or provides a standardized system to measure extracurricular skill development that does not rely on manual or self-reporting. The skill tracking tool tracks applied skills and uses a standardized system to measure, verify and recognize skill development/professional development with high authenticity/accuracy/credibility. Preferably, the system 10 issues issue micro-credentials for applied skills/demonstrated skill development.

In accordance with an exemplary embodiment of the claimed invention, the processor 100 digitally tracks/documents/confirms/verifies independent skill development, i.e. extracurricular, outside of the workplace/classroom, community based development. Unlike a typical online resume profiles, the system verifies applied skills and provides a standardized system to measure/track skill development of users. For example, in a typical profile, such as a LinkedIn™ profile, the user can add her own skills that has not been verified to her profile and others can endorse her. Moreover, in such typical profile, the user generally has a total control as to what is added her profile. That is, the user can make up skills and in such profiling system, there is no standardization to compare skills from one user profile to another use profile. In the claimed system, a user never adds a skill to her profile. The system 10 allocates a skill to the user profile and resume based on the demonstrated skills associated with the actions undertaken by the user in the community or on system platform. The processor 100 tracks the number of times a user has engaged in activities that foster development of a specific skill and updates her profile to reflect such engagement and development. By standardizing the assessment and verification process skill development across different user accounts, the processor 10 can equally compare and contrast the skills of different users.

Actions, that is volunteer activities, leadership rules, learning activities and personal development opportunities are posted to the web/network interface 30, i.e., online platform which is accessible both on the desktop browser or by mobile app on the client device 12. In accordance with an exemplary embodiment of the claimed invention, the processor 100 assess each action for its social impact and associated skill development. Curriculum aligned and/or workplace skills fostered through the user's engagement in the action are assigned to the posting. Users can search for actions with the hard or soft skills that thy need/want to develop and sign up for one that align with their interests via the web or mobile interface 14, 30. At the time of the action, the user shows up to participate (or completes the action if it is virtual or task based). The processor 100 verifies the user's participation and completion through the mobile app or web interface on the client device 12. If it is an in-person activity, the system 10 confirms user's presence via mobile scanning and/or location services which is linked by the system to the corresponding action taking place at that time. The system 10 tracks the amount of time the user participated in the action and checks the user out when she completes the action. The system 10 also time stamps user's completion of the action and adds the record/data to the user action report. The action report record details the data/time of the action, description and the associated skills developed during the activity.

The user can track her skill development in her dashboard through their action report and skill graphs that show their top skills, i.e., the ones that she applied/demonstrated the most through her Actions. Organizations, such as academic institutions and companies, can specify criteria and particular skill development objectives for users by generating digital badges. These digital badges have a specific set of requirements that a user must demonstrate before earning, e.g., a university may create an Event Marketing badge. To earn this badge, the user must complete 20 Actions that demonstrate the application of the Job Task Planning and Organizing and Campaign Development skills). The system 10 tracks user's completion of the actions with these associated skills and automatically assigns the badge to the user after the user has satisfied the criteria for earning this badge.

Through tracking the completion of actions for both the user and organization, the claimed system eliminates the need for the organization to track/review and manually issue micro-credentials to users for their achievements. Also, the claimed system eliminates the need for the user to record and report on their actions. This improves the accuracy of the records and reduces the subjective nature of skill reporting associated with the currently available system, as well as reducing the requisite administrative labor/manpower. When a user satisfies the criteria/requirement for a badge, the achievement is added to her user profile and displayed on her resume. A user can collect badges, track progress towards their completion and share their achievements.

In accordance with an exemplary embodiment of the claimed invention, the system 10 provides a standardized system to calculate and measure leadership, civic engagement and social impact, i.e., a standardized measure of leadership, leadership score/leadership rating. The system 10 generates a scoring, i.e., impact score, leadership score, civic engagement rating, to rate the leadership capabilities by assessing the user's engagement. Preferably, the processor 100 utilizes an algorithm to assess/measure the leadership capabilities/potential or aptitude of a user/candidate based on standardized set of criteria that considers her activity/engagement, skill development, personal/professional growth or learning and measure social footprint/impact. That is, the processor 100 calculates a metric of an individual's leadership/aptitude/employment candidacy/skill potential/civic engagement/social footprint or impact. The processor 100 utilizes a standardized scoring/rating system to measure the community impact/social footprint/corporate social responsibility of organizations. That is, the processor 100 determines a change/impact score/rating that measures the change that the users and/or organizations create and celebrates/embodies their leadership. A measure of engagement and one's social/leadership effect that involves a calculation of time/commitment and impact. The scores take into account the commitment level, i.e. frequency of participation, intensity (i.e. labor required), quality (i.e. skills required/applied), social impact (i.e. positive community outcomes and socio-economic benefits), and level of engagement (time contributed).

Actions that are uploaded/posted to the system 10 through the web/network interface 30 are assessed across a set of key performance indicators and criteria related to social impact and leadership attributes by the processor 100. Such criteria can include the measured social outcomes of the activities/contributions of the user, i.e., environmental effect such as items recycled, the types of items recycled, the influence of actions on reducing fossil fuels or waste; socio and economic benefits such as people helped, jobs created, etc., as well as the quality of engagement required from the user, i.e. intensity of labor, skills required, length of engagement/time commitment, etc. Each performance indicator/impact criteria is assigned a score and the total rating/value of the action is the sum.

Credit/points are earned by users based on the completion of the actions and the associated socio-economic effect of said Actions. Actions receive a base score and the score becomes of a coefficient of the time that a user commits to the activity/task to relate their engagement. For example, a peer mentoring activity can be assessed based on the number of peers that are mentored through the duration of the activity and the skills utilized by the mentor to facilitate the activity to provide a base score of 10 credits/points per hour. The mentor commits 3 hours in the night to the activity. Their score becomes 10×3=30 credits/points for the completion of the action.

Abandoned commitments, i.e., signing up and not showing up for an action or producing poor quality work, result in a reduction of user's score/rating. This contributes to the system's score/rating being reflective of the user's aptitudes and quality of leadership which in turn provides organizations and employers a tool to measure candidacy for programs and employment positions.

The system 10 also assigns a score/rating to the organization. Their rating is based on the cumulative outcomes of their actions and members. Their hosted actions, i.e., community contributions as an organization, programs, events, fundraising activities, etc., are assigned a base score as described herein. Organizations receive credit based on the total engagement generated through their actions and measured social impact. For instance, Sally participates for 2 hours in organization Awesome's sponsored/supported action which is 10 credits/points per hour. She earns 20 credits/points total. Bob participates for 1 hour and earns 10 credits/points total. Organization Awesome would earn a cumulative total of 30 credits/points, contributions of both Sally and Bob. This rating/score helps identify organizations with high impact programs, those that are actively engaged in the communities and the performance/ROI of their running initiatives/programs.

Credits/points earned are showcased on user and organization profiles. They can be featured on leaderboards and can compare their score to others in similar markets. Scores can be used to search for actively engaged, motivated and high performing user candidates. Organization scores help industry stakeholders and other organizations in identifying high performing candidates for investment/partnership/community support as well as search organizations based on their social footprint and civic engagement.

Sample description of services: Operation of a loyalty rewards program, advertising and promotion of wares and services of others by means of a loyalty rewards program, providing information and incentives to consumers with respect to making better choices for themselves and their communities in the fields of community service, skill development, waste reduction, recycling, health and fitness, social awareness and the environment. This context is referring to one exemplary application/use of the rating/scoring system to facilitate an impact based rewards programs, i.e., the network/web interface 30 integrates gameification and leaderboards to spotlight achievements/progress of users and organization with high scores.

An expansion/further exemplary application of the score/rating system is as an incentive/impact recognition program. As users increase their rating and score, they can qualify to receive special rewards, gifts, incentives monetary or other recognitions of their achievements, commitment, contributions and overall engagement.

As used herein, “actions” can include but not limited to volunteer work, community leadership, training, learning activities, personal and/or professional development, skill development activities, fundraising, cause advocacy, donations, and positive contributions.

As used herein, “types of actions” e.g. time based (i.e. volunteer and training) and participation based (i.e. tracked upon completion and not dependent on the variable of time).

As used herein, “Impact Assessments” include positive social effect of actions across a variety of community impact criteria such as environmental effect, people helped, causes supported, dollars raised, etc.

The claimed invention provides a novel solution for tracking and validating action. Particularly, the claimed system and method removes the need for self-reporting and enable real-time/on the spot recognition. The claimed system and method removes the problems associated with self-reporting by removing self-reporting from the process and combines tracking/validation in one step. Also, the claimed system 10 reduces risk of human error, standardizes the process by taking away the subjective nature of self-reporting and improves overall transparency/accuracy in the data. Further, the claimed system 10 provides real-time/on the spot tracking/validation/recognition. The system 10 updates the record in real-time as the actions occur and are completed. The claimed invention combines several steps into one: actions are tracked, validated and their outcomes/impacts are measured. In summary, the claimed invention eliminates/reduces the manpower/manual labor required to track outcomes and monitor participation/engagement/contributions/action.

### Example

A user wants to volunteer/participate in a marathon event and when the user arrives at the location, the system 10 automatically tracks the user's presence, calculates user's time for as long as the user is there, and when the user is done, the system 10 adds the user's total contributions to a verified record that the user (and the user's employer, educator or marathon host organization) can access. Furthermore, the system 10 calculates the skills developed during this activity along with measured community outcomes/impact, and updates the user's record to reflect the developed skills.

Accordingly, the claimed invention has a number of applications and benefits over the currently available systems and methods. The claimed system 10 can track and report on volunteer hours without the use of self-reporting. The system 10 provides a solution to authentically validating skill development outside of the classroom for schools, i.e., without the claimed invention, educators lack a standardized way to track student experiential learning. The claim system eliminates the subjective process based on the supervisor, eliminates/reduces the high risk of forgery by students involved with self-reporting, and significantly reduces or eliminates the administrative labor required to review, validate and then issue skill credit—which is time intensive. The claimed system provides companies with a transparent and trusted method for verifying employee participation and activities outside of the office. For organizations that need to track physical donations, i.e. there really isn't a digital solution for someone to track the number of canned goods, clothing items and so donated. The current system would involve someone to manually count and input/log this information into a digital format).

In generating living/real-time resume, the currently available methods suffer from the same problems as with tracking volunteer participation. Resumes/profiles are highly subjective, and have a high risk of forgery and inaccuracies. It also suffers from problem stemming from self-reporting. The resumes/profiles are created by the candidate/user with little to no third-party validation or verification of their experience. Skills are loosely reported and arbitrary. The closest to validated skills besides an educational degree is the endorsed skills from an online profile, such as LinkedIn™. In this context, the skills are voted by people and do not reflect a standardized system of evaluation as required in the claimed invention. The closet to experience validation is listing references. All data is generally in the past/outdated. Digital solutions currently available still require a user to input the content.

In accordance with the claimed invention, the system 10 provides real-time/live view of a candidate's experience and resume. The resume is self-populated by the system without the candidate inputting data—does not require updates from the candidate. Unlike the currently available system, the claimed system 10 validates/verifies experiences and actions with enhanced transparency. Demonstrated skills are backed by searchable data from a candidate's actions, i.e. the system links the demonstrated skills back to user's real examples of when the skills were applied and how. Experience goes beyond standard work context to included measured outcomes and social impact, the data is not arbitrarily chosen/reported but backed by verifiable and searchable actions by a candidate.

### Blockchain/Distributed Ledge for Social Action/Impact Measurement of One's Social and Environmental Performance

Blockchain is a type of distributed ledger or decentralized database that keeps records of digital transactions. Blockchain networks can be private with restricted membership similar to an intranet, or public, like the Internet, accessible to any person in the world. At its core, blockchain is a distributed, cryptographic, digital record of entries, commonly referred to as a ledger. Each entry in the ledger is contained within a block and each block is cryptographically linked to a previous block in the ledger, thereby forming a chronological “blockchain”. The chain provides, in theory, an immutable record of all transactions ever made for a particular unit of digital “currency”, or with respect to an identified digital asset. Copies of the chain are intended to be distributed among system participants, providing the system with transparency. The encryption that is used with the ledger, as well as its decentralization, provides a level of trust for system users that is, in traditional currency systems, provided by government or banking authorities.

In accordance with an exemplary embodiment of the claimed invention, the claimed invention uses similar approach/underlying mechanism of blockchain to create a distributed ledger of an individual's and/or organization's social and environmental performance (or more broadly speaking the devotion of their time, impact of their action and community contributions). Rather an immutable record of all transactions ever made for a particular unit of digital “currency”—the system 10 tracks the allocation of their time/time invested and outcomes of their actions.

As used herein, actions include volunteer hours, pro-bono service hours, education/training hours where new skills are being developed, physical donations (i.e. school kits, canned food, clothing), recycling, community participation (i.e. event attendance, signing a pledge), etc.

Unlike the standard blockchain model, the claimed invention re-introduces a centralized authority to the system to provide some level of control, effectively creating a novel, hybrid private-public ledger. A centralized authority allows for certain blocks to be added or changed given some trigger events. This enables organizations to use blockchain to document and verify actions in accordance to their programs (i.e. a volunteer manager is able to benefit from the reliability and convenience of blockchain to document and manage the volunteer hours of their supporters; a company can confidently track employee achievements and development in real-time without having to rely on lengthy third-party surveys or audits and report on their social and environmental performance in a transparent and trusted way).

When a user action is carried out (note unlike current systems which would track just digital actions such as liking, sharing or commenting on a post—the claimed system tracks physical action and intangible actions such as the dedication of time as a volunteer). The system 10 documents in real-time and a duplicate digital record is made both on the user's profile and to the relevant organization's record, i.e. host of the event/activity, reporting employer, etc. The system 10 timestamps the validated record and adds to a chain in a linear, chronological order to the accounts of both the user and organization. New records of validated actions are linked to older records, making a chain of records or “living ledger” that show every action made in the history of that blockchain (aka user's and organization's history). The system 10 continually updates the entire chain so that every ledger shows a real-time reflection of the user's achievements and recorded actions, giving each member the ability to measure and compare their impact and share their actions with other users and organizations.

The benefit of the claimed distributed tracking system 10 is a decentralized database of social and environmental impact metadata with real-time update and tracking capabilities. The claimed system 10 documents, validates and shares action with an emphasis on social and environmental performance, social impact and skill achievements) without the need for intermediaries. Trust and collective self-interest, hard-coded into this new native digital medium for value, ensures the reliability and integrity of the data collected/shared; as well as improved efficiency, up-time (i.e., data collection) and convenience for users and organizations to access, understand and share such performance data in meaningful ways. Trust is programmed into the claimed system, and is achieved not by big institutions but by cryptography, collaboration and novel coding. Moreover, the claimed system is malleable to suit the many challenges of different industries and institutions.

In accordance with an exemplary embodiment of the claimed invention, the system 10 comprises a decentralized database for tracking social and environmental performance. It is appreciated that various implementations of the invention can be practiced with various computer system configurations, including hand-held wireless devices such as mobile phones or personal digital assistants (PDAs), multiprocessor systems, microprocessor-based or programmable consumer electronics, minicomputers, mainframe computers, and the like.

The claimed invention also can be practiced in distributed computing environments, where the tasks are performed by remote processing devices that are linked through a communications network. In a distributed computing environment, program modules can be located in both local and remote computer storage media including memory storage devices. With this kind of setting, data integrity can be maintained more securely because there will be a better sense of responsibility by each of the department.

### Dynamic Data Streams (Impact Measurement, Volunteer Management, Corporate Social Responsibility) in a Social Network Platform

The techniques, methods and systems described herein facilitate the automated documentation and presentation of social action/social achievements/skill development, published or otherwise made public by “experts” and key influencers on particular topics. As such, users that may be interested in particular skill development or community opportunities but may not know who to connect with in order to receive the most pertinent information. In an embodiment, the system uses topics of interest identified by the user and/or automatically identifies topics based on previous completed actions, communication, personal goals, contacts, etc. Individuals, companies, organizations and other entities that have been recognized as highly influential in those topics are identified and, without explicit actions by the user, adds content generated by the influential entities to the user's content data feed.

The claimed invention contemplates that many changes and modifications may be made. Therefore, while the presently-preferred form of the system has been shown and described, and several modifications and alternatives discussed, persons skilled in this art will readily appreciate that various additional changes and modifications may be made without departing from the spirit of the invention, as defined and differentiated by the following claims.

1. A computer-implemented method for calculating a metric of a user's social or environmental performance among a plurality of users of a collection of social network application platforms, the method comprising the steps of:
storing, on a physical memory device, computer executable instructions for identifying opportunities for social action be included in a content feed addressable to the user and providing opportunities generated by organizations to the user; and
providing a processor for accessing and executing the computer executable instructions, that when executed by the processor:
monitors interactions between the user and at least one of the plurality of users and the plurality of organizations;
monitors a type of interaction and associated social or environmental impact of the interactions;
stores the interactions in a profile unique to the user;
determines from the profile unique to the user at least one social/environmental achievement or new contribution by the user; and
for each of said at least one social/environmental achievement or contribution, assigns a numerical value to an amount, a frequency, a location of the user, and a quality of the profile unique to the user data representative of the user's influence in each of the at least one social/environmental achievement or contribution.

2. The computer-implemented method of 1, wherein the user's influence is global and based on at least one of:
a number of documented actions, achievements and social contributions the user has taken with other users of said plurality of users via a service provider's social network application platform;
a frequency of actions and positive contributions between the user and the organizations via the service provider's social network application platforms;
a quality or a measured applicable impact of interactions and documented actions between the user and the other users via the service provider's social network application platform; and
an amount of time invested by the individual towards the documented actions and positive contributions.

3. The computer-implemented method of claim 1, further comprising a step of determining the at least one social and environmental impact achievement of the user results from a statistical analysis of data in the profile unique to the user.

4. The computer implemented method of claim 3, wherein the statistical analysis focuses on at least one of social indicators, skills, and community/impact outcomes contained in the profile unique to the user.

5. The computer implemented method of claim 1, wherein the computer executable instructions when executed by the processor further generates a pairing list comprising a rank ordering of a plurality of individuals whose assigned numerical value for a specific social/environmental performance indicator is higher than assigned numerical values of other users of the social network groups for the same specific social/environmental performance indicator.

6. The computer-implemented method of claim 5, wherein the generated pairing list is multi-dimensional to provide additional numerical values for each sub-topic of a topic of interest.

7. The computer-implemented method of claim 5, wherein the computer executable instructions when executed by the processor further receives user-specified opportunities of interest from users; and automatically identifies sources or organizations with opportunities for the users using the pairings list.

8. The computer-implemented method of claim 1, wherein the assigned numerical value takes into account an activity of the user and one or more previously documented social/environmental achievements of the user.

9. The computer-implemented method of claim 5, wherein the assigned numerical value takes into account a location of the user, an activity of the user, and one or more previously documented social/environmental achievements of the users.

10. A system to implement the computer-implemented method of claim 1, comprising:
a plurality of processor-based client devices, each client device being uniquely associated with a user; and
a processor-based web application server comprising a processor and a memory, wherein the processor is configured to generate a pairing list comprising a rank ordering of a plurality of individuals whose assigned numerical value for a specific social/environmental indicator is higher than assigned numerical values of other users of the social network group for the same specific social indicator.

11. The system of claim 10, wherein the processor is structured and arranged to identify social values and opportunities of interest of the user based at least in part on stored information and to identify one or more social action opportunities or organizations not previously known to the user as relevant sources of information about the identified social/environmental indicators of interest.
